(19) United States
(12) Patent Application Publication
(10) Pub. No.: US 2007/0220587 A1
(43) Pub. Date: Sep. 20, 2007

(54) Systems, Methods, and Apparatus for Most Advantageous Media Delivery for Rich Media Applications

(76) Inventor: Douglas E. Loyer, Littleton, MA (US)

Correspondence Address: Brian M. Dingman;Mirick, O'Connell, DeMallie & Lougee, LLP, 1700 West Park Drive, Westborough, MA, 01581, US

(21) Appl. No.: 11/686,814

(22) Filed: Mar. 15, 2007

Related U.S. Application Data
(60) Provisional application No. 60/782,572, filed on Mar. 15, 2006.

(51) Int. Cl. H04L 9/00

(52) U.S. Cl. 726/1

(57) ABSTRACT

The invention includes a method for delivering rich media content, including audio and/or video content, to a user in a client-server network by using the most advantageous source and protocol of the available sources and protocols. A rich media application at a client computer receives a global media policy file that contains one or more media policy file entries, and each media policy file entry identifies one server computer and a protocol associated with the one server computer. The rich media application sends one or more connection requests to the servers identified in the global media policy using the protocol associated with each server. A data connection for delivering rich media content is established with the first server computer to respond to the connection request.

### CROSS-REFERENCE TO RELATED APPLICATION

This invention is based upon and claims the benefit of priority from U.S. Provisional Application Ser. No. 60/782,572 filed Mar. 15, 2006, the entire contents of which are incorporated by reference herein.

### FIELD OF THE INVENTION

The invention relates to data communication in a computer network. More particularly, the invention relates to improved systems, methods, and apparatus for delivering rich media content, including audio and/or video content, to a user in a client-server network by using the most advantageous source and protocol of the available sources and protocols.

### BACKGROUND OF THE INVENTION

Client-server computer networks are well known in the art. An example of a client-server computer network is the computer network commonly known as the Internet. A typical client-server computer network includes one or more client computers connected to one or more server computers. Client computers typically access data or content and application programs from server computers. For example, a web browser running on a client computer may connect to a web server running on a server computer to retrieve and display web pages.

A simplified block diagram of a client computer is generally shown in FIG. 1. Client computer 101 may include, but is not limited to, well know components such as data processor 102; volatile and non-volatile primary memory 103; secondary memory 104 such as hard disks, floppy disks, or other removable media; network interface components 105; display devices and corresponding drivers 106; and audio recording and rendering devices 107. Client computer 101 runs an operating system 108, such as the Microsoft's Windows NT operating system. In addition, client computer 101 may run an Internet browser 109, such as Microsoft's Internet Explorer.

A simplified block diagram of a server computer is generally shown in FIG. 2. Server computer 201 includes well known components similar to those of a client computer, including data processor 202; volatile and non-volatile primary memory 203; secondary memory 204 such as hard disks, floppy disks, or other removable media; network interface components 205; and display devices and corresponding drivers 206. Server computer 201 runs an operating system 207, such as the Microsoft's Windows NT operating system. Server computers may be identified by their DNS (Domain Name Server) hostname, such as the DNS hostname accelacommunications.com.

Client and server computers in a network communicate via protocols. A protocol is a convention or standard that controls or enables the connection, communication, and transfer of data between two computers. Protocols may be implemented in hardware, software, or a combination of the two. The Internet Protocol (IP), the Transmission Control Protocol (TCP), the User Datagram Protocol (UDP), and the Hypertext Transfer Protocol (HTTP) are all well known protocols. Protocols further employ ports, which are used to map communications to specific applications running on the client and server computers.

A simplified block diagram of a client-server computer network is shown in FIG. 3. Network 300 may include one or more client computers 301 and one or more server computers 311 and 312. Server computer 312 may communicate directly with client computer 301. Server computer 311 may communicate with client computer 301 through firewall 321. Firewall 321 may be configured to prevent data from traversing through certain inbound or outbound ports, as determined by the firewall configuration parameters. For example, firewall 321 may be configured to prohibit any data transfer between client computer 301 and server computer 311. Alternatively, firewall 321 may be configured to allow only specific TCP or UDP connections. For example, firewall 321 may be configured to allow outgoing TCP connections to a first set of ports, and outgoing UDP connections to a second set of ports.

Without a firewall, any type of data and/or protocol may be communicated between a client computer and a server computer, provided the appropriate software and/or hardware are used. For example, as shown in FIG. 3, server computer 312 is located on the same side of firewall 321 as client computer 301, such that firewall 321 is not located in the communication path between server computer 312 and client computer 301. Because of this configuration, few, if any, of the ports that client computer 301 may use to communicate with server computer 312 may be blocked.

As shown in FIG. 3, server computer 311 may also communicate with client computer 301 through proxy server 331. A proxy server is a computer that allows indirect connections between a client computer and a server computer around a firewall. Proxy server 331 may allow, for example, HTTP data, which may otherwise be blocked by firewall 321, to be transmitted between server computer 311 and client computer 301.

Within a client-server network, such as the one shown in FIG. 3, data or content may be available from more than one server, via one or more protocols. In addition, the content itself may be available in more than version, where each version may be of a different quality. For example, a rich media application combines multiple forms of information content, such as audio, video, text, and graphics. The rich media content may be encoded at several different levels of quality, where higher quality rich media content requires more bandwidth to deliver than rich media content of a lower quality. In addition, the audio and video portions of the rich media content must typically be delivered separately from other portions of the rich media content due to their relatively large size and bandwidth requirements.

There is no one best, or most advantageous, source or protocol for delivering content to all users. For example, one set of users may be using client computers that are behind a firewall, where the firewall prevents some server computers or protocols from delivering audio or video content, another set of users may be using client computers in a network that forces all content requests to go through a proxy server, and a third set of users may be using client computers on networks that do not have sufficient available bandwidth to support the highest quality media available. In addition, the content may be offered on several server computers, and some server computers may have capacity limitations, such as those that prevent them from accepting additional users, while some server computers may offer better network connectivity to users that are in the same geographical area or use the same network provider. In addition, the firewalls and proxy servers may have performance limitations that affect content delivery. Further, some server computers may be operated by third-party providers as part of a “Content Delivery Network,” where the content provider may be charged per use or by bandwidth capacity. Operating costs may reduced if network communication can be directed to the most cost effective server computer that provides an acceptable user experience.

While there are many ways in which rich media content may be delivered, the content is preferably delivered to the user in a way that not only provides the best possible user experience, but also minimizes the cost of media delivery. Ideally, the user should not have to make decisions about how the content is delivered.

In the prior art, selecting the best or most advantageous method of content delivery typically requires a high level of technical expertise on the part of the user at a client computer. For example, in the prior art a user may need to understand the topology of the network, the different protocols that are available for use within the network, and the protocols that are permitted to traverse the firewall before the user can properly configure the client computer. This level of technical expertise is likely to be beyond that of a typical user. In many cases, a user at a client computer is unaware of the security rules that apply to the network, and may have to rely on trial and error to manually configure a connection if there are restrictive firewall and proxy rules. As a result, users in the prior art have often found it difficult to configure their client computers to communicate effectively with the network, and many users may not be able to configure a connection at all. These difficulties are compounded when changes are made to the network topology or the firewall configuration parameters.

Further, even if the user has configured the client computer to communicate with a server computer through a firewall and/or a proxy server, there is no guarantee that the user has properly selected the best server computer or the best protocol, which may result in a lower quality user experience. These difficulties affect both the users and the providers of content, reducing audience sizes for audio, video, and rich media applications.

To overcome some of these limitations, there have been a number of prior art inventions designed to permit a client computer in a client-server network to automatically select the most advantageous protocol to communicate with a server computer. For example, U.S. Pat. No. 5,999,979 to Vellanki, et al. describes an autodetect mechanism, which employs multiple threads, through multiple connections, to initiate communication with a server computer. Each thread may employ a different protocol, and requests the server computer to respond to the client computer using the protocol associated with that thread. The client computer monitors the set of responses received from the server computer, and may select the predefined best protocol, or select another protocol from the set of protocols received back by the client computer within a predetermined time period. The selected protocol is then saved for subsequent connections. This method, however, does not easily accommodate changes in the network topology, because the connection selection is generally persistent. Network changes may only be accommodated if the client computer is instructed to re-execute the autodetect mechanism. In addition, since each application at each client computer determines its own connection policy, network changes must be propagated individually to each application on each client computer, a task that may be inefficient and time-consuming.

The present invention alleviates or eliminates at least some of the disadvantages of the prior art. These and other advantages of the present invention will be apparent from the description set forth below.

### SUMMARY OF THE INVENTION

The present invention provides improved systems, methods, and apparatus for delivering rich media content, including audio and/or video content, to a user in a client-server network by using the most advantageous source and protocol of the available sources and protocols. In a preferred embodiment, a rich media application at a client computer receives a global media policy file that contains one or more media policy file entries, and each media policy file entry identifies one server computer and a protocol associated with the one server computer. The rich media application sends one or more connection requests to the servers identified in the global media policy file using the protocol associated with each server. A data connection for delivering rich media content is established with the first server computer to respond to the connection request.

Each media policy file entry may also include a delay period, such that each connection request is sent only after the delay period expires. The delay period may be measured from the time the global media policy file is loaded to the client computer. Each media policy file entry may also include a timeout period, such that each connection request is abandoned after the timeout period expires. The timeout period may be measured from the time the connection request is made.

The present invention also includes systems, methods, and apparatus for selecting the quality level of the rich media content, monitoring the established connection, and switching to a lower quality rich media content if the media content delivery rate is less than a desired content delivery rate. The present invention also includes systems, methods, and apparatus for reestablishing a terminated, i.e., lost or dropped, connection.

### BRIEF DESCRIPTION OF THE DRAWINGS

Other objects, features and advantages will occur to those skilled in the art from the following description of the preferred embodiments and the accompanying drawings, in which:

FIG. 1 is a simplified block diagram of a prior art client computer;

FIG. 2 is a simplified block diagram of a prior art server computer;

FIG. 3 is a simplified block diagram of a prior art client-server computer network;

FIG. 4 is a simplified flowchart of a preferred embodiment of the inventive method for delivering rich media content; and

FIG. 5 is a simplified flowchart of the steps associated with each connection request for the preferred embodiment of the invention shown in FIG. 4.

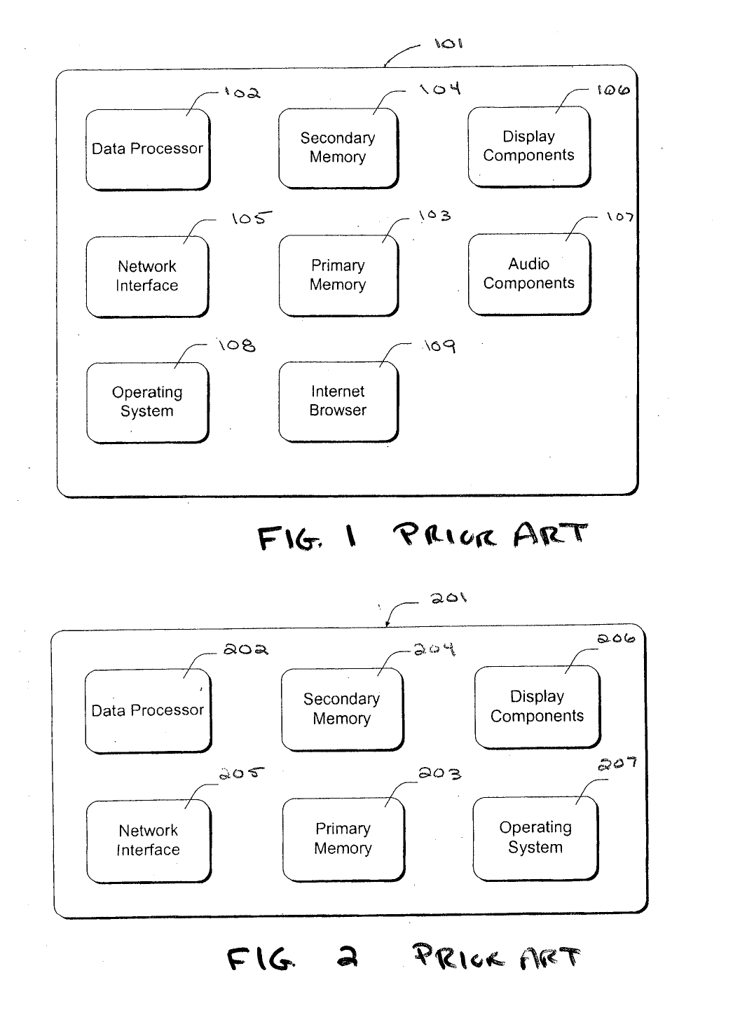

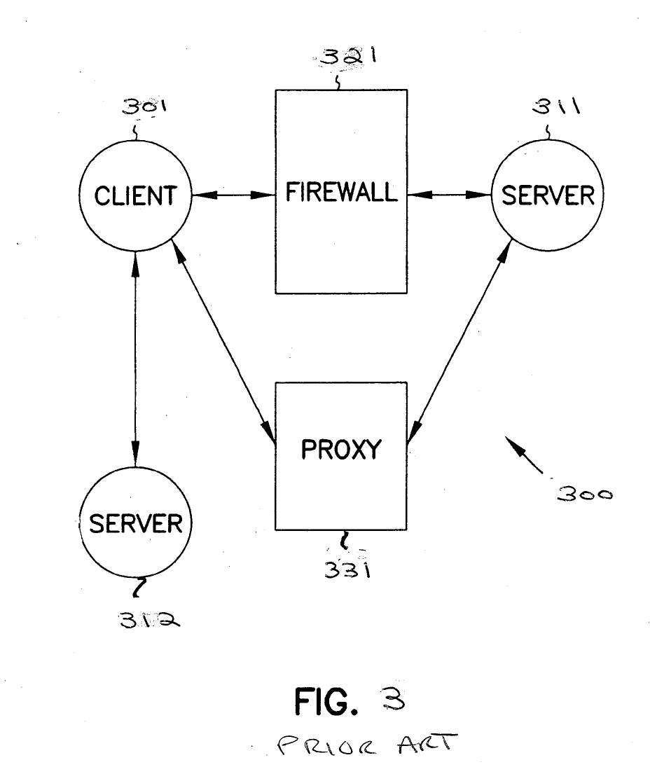

### DETAILED DESCRIPTION OF THE PREFERRED EMBODIMENTS

The present invention relates to systems, methods and apparatus for delivering rich media content, including audio and/or video content, to a user in a client-server computer network by using the most advantageous source and protocol of the available sources and protocols.

The present invention is described below in terms of a rich media application, although it is understood that the invention is not limited to this application. The invention may be adapted for use for other types of data communication applications.

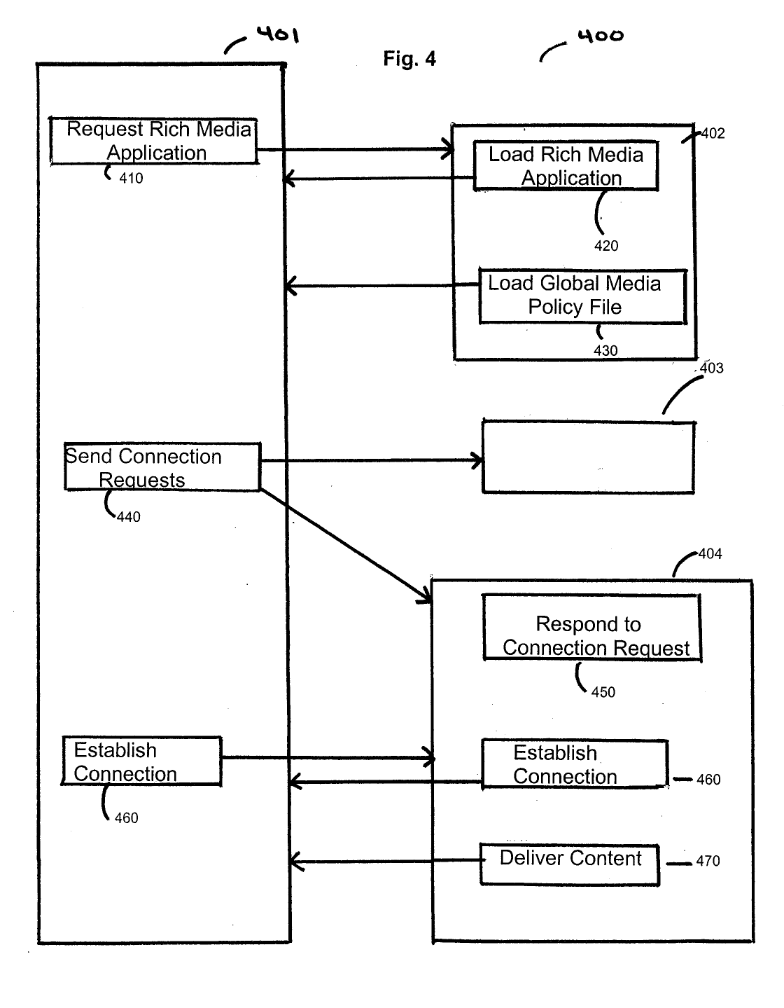

A simplified flowchart of a preferred embodiment of the inventive method for delivering rich media content 400 is generally shown in FIG. 4. At step 410, a user at client computer 401 requests a rich media application, or rich media player, from server computer 402, typically through an Internet browser. At step 420, the rich media application is loaded to client computer 401 from server computer 402. At step 430, the rich media application loads a global media policy file to the client computer. Once the global media policy file is loaded, the rich media application initiates the process of selecting and establishing the most advantageous connection for delivering the rich media content. At step 440, the rich media application at client computer 401 sends one or more requests to one or more server computers 403 and 404, as defined by the entries in the global media policy file. At step 450, server computer 404 is the first to respond to the request from client computer 401. At step 460 the rich media application at client computer 401 establishes a connection with server computer 404. At step 470, the rich media content is delivered to the user at client computer 401 using the connection established in step 460.

In a preferred embodiment, the global media policy file is not stored on the client computer, but is loaded each time the rich media application is loaded. As a result, the selection of a server computer and a protocol is not persistent, and may change each time the rich media application is loaded. By loading the global media policy file each time the rich media application is loaded, the rich media application is better able to respond to changes in the network, such as when server computers are removed from, or added to, the network. In addition, having a global media policy file allows the connection policy to be separate from the individual rich media applications. Many rich media applications use the same connection policy. An advantage of the present invention, therefore, is that it permits an administrator to modify the connection policy without having to modify the individual rich media applications themselves, thus saving time.

For example, if a server computer becomes overloaded and refuses additional connections, the rich media application will attempt to connect to other server computers, as defined in the global media policy file, and may successfully connect with a different server computer than the one used in a previous connection. In addition, loading the global media policy file each time the rich media application loads may also benefit the user of a portable computer, such as a laptop computer. When used in the office, the office network may be configured with a proxy server and require the laptop computer to make an indirect connection to the network through a proxy server. When used at home, however, the home network may be configured to allow a direct connection to the network without a proxy server or firewall in the communications path. The present invention thus permits the rich media application to deliver content using the protocol and server that is most appropriate for the current network conditions.

In a preferred embodiment, the global media policy file may contain one or more entries, and each entry may contain one or more fields. Each of the entries in the global media policy file is capable of providing the same rich media content.

(i) Server Computer Address: Each entry may specify the address of a server computer that may provide the requested media content. In a preferred embodiment, the server computer may be identified by its DNS hostname. In alternate embodiments, the server computer address may be another unique identifier, including, but not limited to, the server computer's Internet Protocol (IP) address.

The server computer address may further include the identity of a port on the server computer. In a preferred embodiment, the port identity may be identified by its TCP port address. In alternate embodiments, the port identity may be a default value, where the default value is dependent upon the protocol. For example, the default port identity for the Flash real time protocol is preferably port 1935, and the default port identity for the tunnel protocol is port 80.

(ii) Content Location: Each entry may specify the location for rich media application content. In a preferred embodiment, the content location is a server-specific value, and the server-specific value is combined with information specific to the rich media application to locate the content on a server computer. In alternate embodiments, the content location may be specified by a directory name and file name, where the directory name and file name are relative to the identified server computer. The content location may also be a default value.

(iii) Protocol: Each entry may specify the name of a protocol to use. Different protocols may require different processing by the server computer. The specified protocols may include, but are not limited to: real time streaming protocol (“RT”); “Akami Tunnel” (“AT”), a protocol for use with Akami's commercial content delivery network; and normal tunnel protocol (“T”).

(iv) Delay Period: Each entry may specify the amount of time to wait before attempting a connection request, also known as a delay period. In a preferred embodiment, the amount of time to wait before attempting a connection request is measured starting from the time the global media policy file is loaded to the client computer. If the global media policy file is already loaded, the delay period is measured from the start of the connection attempt. For example, if the delay period is 500 ms (milliseconds), a connection request will be made approximately 500 ms after the global media policy file is loaded to the client computer. In an alternate embodiment, the wait or delay period is measured from the time a specific rich media content file is requested by the rich media application. The delay period may be used to stagger the connection requests such that the rich media application does not attempt to connect to all available servers with all available protocols at the same time. In alternate embodiments, the delay period may be a default value, such as a default value of zero.

In a preferred embodiment, the order of entries in the global media policy file has no effect on the order in which connection requests are made. The order is determined by the delay period specified in each entry. If several entries have the same delay period, then connection requests for each of these entries will be made at approximately the same time.

(v) Timeout Period: Each entry may specify the amount of time to allow a connection attempt before giving up, also known as a timeout period. In a preferred embodiment, the timeout period starts when the connection request is made. Continuing with the example above, if the timeout period is 400 ms, the timeout period starts at approximately 500 ms, when the delay period has expired. If a connection is not established within approximately the next 400 ms, the connection request is abandoned. In alternate embodiments, the timeout period may be a default value, such as a default value of five seconds.

In alternate embodiments, the global media policy file may contain additional or alternative fields or attributes that indicate additional capabilities of specific server and protocol combinations, such as support for a playlist. The rich media application will pass over the entries in the global media policy file that do not support the capabilities it requires.

A sample global media policy file, in accordance with a preferred embodiment of the invention, is shown below:

```
<global>
    <server address=“flashcdn.itworld.com” app=“/ondemand”
      prefix=“flash/” type=“RT” delay=“500” timeout=“10000”
      list=“true” />
    <server address=“flashcdn.itworld.com” app=“/ondemand”
      prefix=“flash/” type=“AT” delay=“500” timeout=“10000”
      list=“true” />
    <server address=“flashny.itworld.com:80” app=“/accelacast/test”
      prefix=“” type=“RT” delay=“0” timeout=“10000” list=“true” />
    <server address=“flash.itworld.com:1755” app=“/accelacast/test”
      prefix=“” type=“RT” delay=“50” timeout=“10000” list=“true” />
    <server address=“pcomm.itworld.com” app=“/” prefix=“” type=“PC”
      delay=“4000” timeout=“1500” list=“false” />
</global>
```

The global media policy file may be configured to use a shorter delay period for server computers that operate at the lowest cost and for protocols that provide the best performance. For example, a high cost, but also high capacity content delivery server may be configured with a longer delay period, so it is less likely to be used to establish a connection unless other server computers are unreachable or are overloaded, or the connection path between the user and the other server computers experience large delays. Similarly, a lower performing protocol that may work with some proxy servers may be configured to have a longer delay period, thereby allowing a higher performing direct server computer to connect first.

In an alternative embodiment, the rich media player loads a local program configuration file in addition to the global media policy file. Each local program configuration file applies to a specific program. A local program configuration file may be used, for example, if a network administrator requests that a particular server be used, or if a local area network has an internal firewall parameter that is incompatible with the global media policy file. The rich media application reads the local program configuration file first. If a local policy is defined in the local program configuration file, the local policy is used. If a local policy is not defined, or if the local program configuration file is not loaded, the global media policy file is used. In another embodiment, the rich media application includes a user dialog to allow the user to override the automatic source and protocol selection.

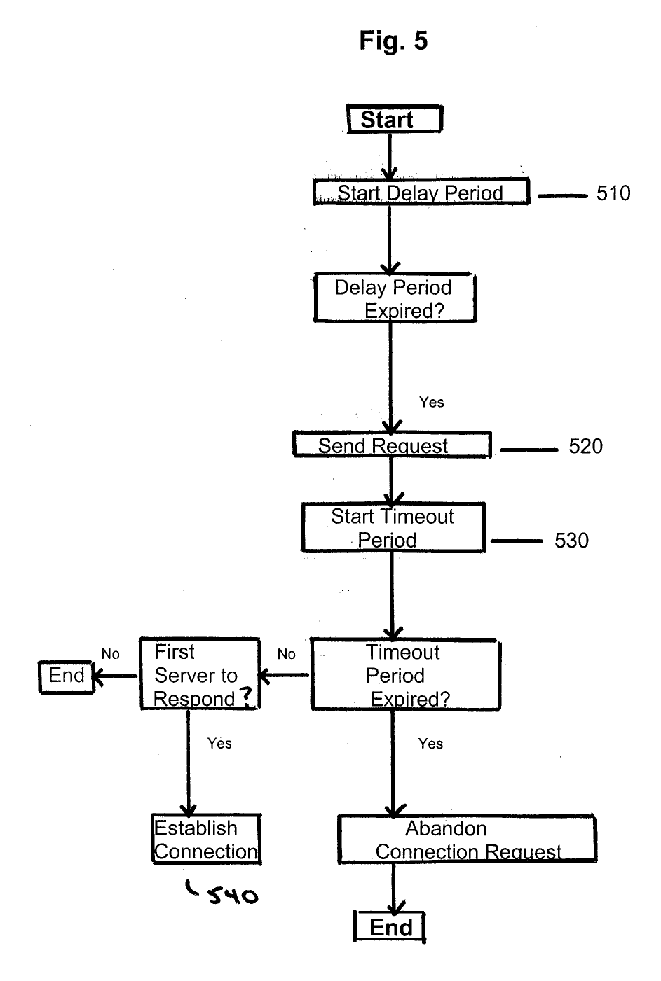

With further reference to FIG. 4, in step 440, the rich media application sends one or more connection requests to one or more server computers, as defined by the entries in the global media policy file. A simplified flowchart of a preferred embodiment of the steps associated with each connection request is shown in FIG. 5. At step 510, the rich media application starts the delay period. At step 520, when the delay period has expired, the rich media application sends a request for the application and filename to the server computer, using the protocol, and at step 530, starts the timeout period. At step 540, a connection is established if the server computer is the first to respond to the request.

As described, several connection requests may be attempted concurrently. In practice, however, some client computers may be behind proxy servers that limit the number of outstanding connection requests. Attempting too many connection requests may result in a timeout.

Once a connection is established, the rich media application may select what version, or quality level, of the rich media content to use. Rich media content may be encoded at server different levels of quality, each with different bandwidth requirements. In the preferred embodiment, the rich media application will initially use the highest quality rich media content. The rich media application also maintains a sorted list of available media files. For example, the list may include two audio files, one low quality and one high quality, or three video files, one low, one medium, and one high quality.

The rich media application incorporates a state machine that monitors the current mode of the rich media player, which may include, but is not limited to, “paused,” “playing,” and “seeking” modes. During regular operation, the rich media application buffers some content to allow for short interruptions in the connection. In a preferred embodiment, at least one second of rich media content is buffered. If the rich media application is in “playing” mode, and the content delivery rate is less than the desired content delivery rate, with little content in the buffer, the rich media application may attempt to switch the to the next lowest quality media content. For example, if the currently playing video file is high quality, the rich media application will attempt to play the medium quality video file. If the lowest quality media file is already playing, then nothing more can be done and the rich media application will continue to deliver the current media file. In a preferred embodiment, the desired content delivery rate is the real-time rate.

The rich media application monitors the status of the rich media content delivery at regular intervals. In a preferred embodiment, the rich media application checks the status of the rich media content delivery and calculates the download progress twice per second. The download progress is the amount of media played since the last check, plus the amount of additional media downloaded into the buffer since the last check, minus the amount of time since the last check. The result can be negative if the media is downloading in less than real time. All values are measured in time. A list of the last eight values for the download progress, equivalent to four seconds, is maintained. If the total download progress over the previous four seconds is negative, and if the amount of media in the buffer is less than one half of one second, the rich media application will attempt to switch to a lower quality media file. In a preferred embodiment, the rich media application will not play any video media until at least one second of media is in the buffer, at which point the rich media player will transition to the “playing” mode, and the list of the last eight values of download progress will be cleared. Note that in alternative embodiments, different sample rates, different numbers of samples, and different thresholds could be used.

In another aspect of the invention, if a connection is lost or dropped, which may be due to a server computer crash or network problems, the rich media application will restart the connection process using the global media policy file that has already been downloaded. The new connection may be with the same server computer, or with a different server computer. If a new connection cannot be established, the user is notified with an error message.

The inventive methods described above may be implemented either in software or hardware, such as via an IC (integrated circuit) chip. The invention may also be embodied as computer readable code on a computer readable medium. The computer readable medium is any data storage device that can store data and that can later be read by a computer system. Examples of computer readable medium include, but are not limited to, random access memory, read only memory, CD-ROMS, optical data storage devices, and magnetic tape. The computer readable code may also be distributed over a network.

Although specific features of the invention are shown in some figures and not others, this is for convenience only, as some features may be combined with any or all of the other features in accordance with the invention.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A method for establishing a data connection between a client computer and a server computer, the client computer configured to be coupled to one or more server computers via a computer network, the method comprising:
receiving, at the client computer, a media policy file, wherein the media policy file contains one or more media policy file entries, and wherein each media policy file entry identifies one server computer and a protocol associated with the one server computer;
sending, from the client computer, one or more connection requests, wherein each connection request is sent to one server computer identified in one media policy file entry using the protocol associated with the one server computer; and
establishing a data connection between the client computer and the first of the one or more server computers that responds to the connection request.

2. The method of claim 1, wherein each media policy file entry further includes an associated delay period and each connection request is sent only after the associated delay period expires.

3. The method of claim 2, wherein the delay period is measured from a time when the media policy file is received at the client computer.

4. The method of claim 1, wherein each media policy file entry further includes an associated timeout period and each connection request is abandoned after the timeout period expires.

5. The method of claim 4, wherein the timeout period is measured from a transmitting time of the connection request.

6. The method of claim 1, wherein each media policy file entry further includes a port identifier associated with the one server computer.

7. The method of claim 1, further comprising:
receiving, at the client computer, audio or video data, where the audio or video data is sent over the established data connection.

8. The method of claim 7, further comprising:
monitoring, at the client computer, the rate at which the audio or video data is sent over the established data connection.

9. The method of claim 1, further comprising:
monitoring, at the client computer, the established data connection; and
establishing a new data connection if the established data connection is terminated.

10. A computer-readable medium containing computer-readable instructions for establishing a data connection between a client computer and a server computer, the client computer configured to be coupled to one or more server computers via a computer network, the computer-readable instructions comprising:
computer-readable instructions for receiving, at the client computer, a media policy file, wherein the media policy file contains one or more media policy file entries, and wherein each media policy file entry identifies one server computer and a protocol associated with the one server computer;
computer-readable instructions for sending, from the client computer, one or more connection requests, wherein each connection request is sent to one server computer identified in one media policy file entry using the protocol associated with the one server computer; and
computer-readable instructions for establishing a data connection between the client computer and the first of the one or more server computers that responds to the connection request.

11. The computer-readable instructions of claim 10, wherein each media policy file entry further includes an associated delay period and each connection request is sent only after the associated delay period expires.

12. The computer readable instructions of claim 11, wherein the delay period is measured from a time when the media policy file is received at the client computer.

13. The computer-readable instructions of claim 10, wherein each media policy file entry further includes an associated timeout period and each connection request is abandoned after the timeout period expires.

14. The computer-readable instructions of claim 13, wherein the timeout period is measured from a transmitting time of the connection request.

15. The computer-readable instructions of claim 10, wherein each media policy file entry further includes a port identifier associated with the one server computer.

16. The computer-readable instructions of claim 10, further comprising:
computer-readable instructions for receiving, at the client computer, audio or video data, where the audio or video data is sent over the established data connection.

17. The computer-readable instructions of claim 10, further comprising:
computer-readable instructions for monitoring, at the client computer, the rate at which the audio or video data is sent over the established data connection.

18. The computer-readable instructions of claim 10, further comprising:
computer-readable instructions for monitoring, at the client computer, the established data connection; and
computer-readable instructions for establishing a new data connection if the established data connection is terminated.

19. A system comprising:
a client computer having computer-executable instructions for
receiving a media policy file, wherein the media policy file contains one or more media policy file entries, and wherein each media policy file entry identifies one server computer and a protocol associated with the one server computer, and
sending one or more connection requests, wherein each connection request is sent to one server computer identified in one media policy file entry using the protocol associated with the one server computer; and
a server computer having computer-executable instructions for
receiving the connection request from the client computer, and
responding to the connection request to establish a data connection with the client computer using the associated protocol.

20. The system of claim 19, where the client computer further includes computer-executable instructions for
receiving audio or video data from the server computer over the established data connection.

21. The system of claim 20, where the client computer further includes computer-executable instructions for
monitoring, at the client computer, the established data connection, and
computer-executable instructions for establishing a new data connection if the established data connection is terminated.
